(19) United States
(12) Patent Application Publication
(10) Pub. No.: US 2016/0103978 A1
(43) Pub. Date: Apr. 14, 2016

(54) Apparatus, System, and Method for Managing Prescriptions

(71) Applicant: RxFlo, LLC, Murray, UT (US)

(72) Inventor: Jared Stong, Draper, UT (US)

(73) Assignee: RXFLO, LLC, Murray, UT (US)

(21) Appl. No.: 14/510,798

(22) Filed: Oct. 9, 2014

(51) Int. Cl. G06F 19/00

(52) U.S. Cl. CPC G06F 19/3481

(57) ABSTRACT

A system for managing prescriptions. The system includes a server to operate a prescription manager, a prescription manager, and a client. The server includes a processing device and a memory. The prescription manager includes a prescription receiver operating on the processing device of the server to receive from a care provider a prescription for a patient. The prescription receiver includes a medication manager to display a recommendation in response to selection of a medication to be administered to the patient. The client interacts with the prescription manager and is in communication with the server via a network. The client displays the recommendation.

### CROSS REFERENCE TO RELATED APPLICATIONS

Not applicable.

### BACKGROUND

Traditional methods of prescribing medications are prone to errors and inefficiencies. Health care professionals often prescribe medications without knowledge of the formulary status of the medication and may not know of preferable alternatives. This can lead to unnecessary costs to a provider and/or a patient. It can also lead to delay in dispensing medications.

### BRIEF DESCRIPTION OF THE SEVERAL VIEWS OF THE DRAWINGS

FIG. 1 is a block diagram depicting one embodiment of a system for managing prescriptions.

FIG. 2 is a block diagram depicting one embodiment of the prescription manager of FIG. 1.

FIG. 3 is a block diagram depicting one embodiment of the prescription Receiver of FIG. 2.

FIG. 4 is a block diagram depicting one embodiment of the medication manager of FIG. 3.

FIG. 5 is a block diagram depicting one embodiment of the prescription queue manager of FIG. 2.

FIG. 6 is a block diagram depicting one embodiment of the patient detail manager of FIG. 2.

FIG. 7 is a block diagram depicting one embodiment of the cycle manager of FIG. 2.

FIG. 8 is a block diagram depicting one embodiment of the formulary builder of FIG. 2.

FIG. 9 depicts a flowchart diagram showing one embodiment of a method for managing prescriptions.

FIG. 10 is a block diagram depicting one embodiment of a computer system for facilitating the execution of the prescription manager of FIG. 1.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity. The terms “Rx” and “prescription” are used interchangeably herein. As used herein, a “user” refers to a person who uses the system to enter and manage prescription for a patient. An example of a user is a registered nurse caring for the patient. As used herein, an “administrator” refers to a person who has been authorized to make administrative decisions relating to prescriptions. For example, an administrator may be a director of nursing (“DON”) who has been authorized to allow or deny prescription of non-formulary medications. As used herein, a “prescription signatory authority” refers to a person authorized to sign a prescription, such as a physician or an advanced practice nurse (“APN”).

While many embodiments are described herein, at least some of the described embodiments provide a method for managing a prescription. A prescription manager receives input from a health care provider describing the prescription. The prescription manager may provide feedback to the health care provider in response to the prescription, including recommendations relating to a selected medication or a combination of a selected medication and a selected patient. The prescription manager may require administrative approval of a prescription. In some embodiments, the prescription manager transmits the prescription to a pharmacy for fulfillment.

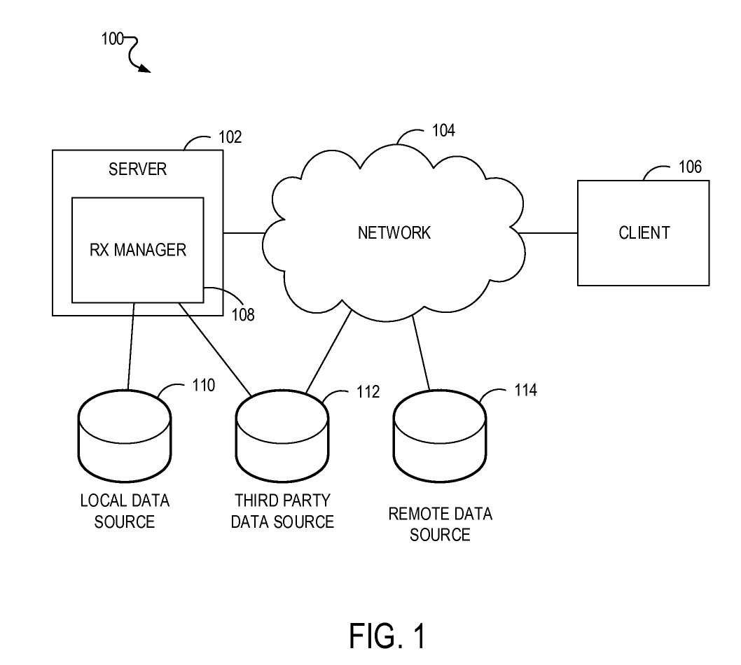

FIG. 1 is a block diagram depicting one embodiment of a system 100 for managing prescriptions. The system 100 includes a server 102, a network 104, and a client 106. The system 100 manages prescriptions and provides access to a prescription manager 108 via the network 104.

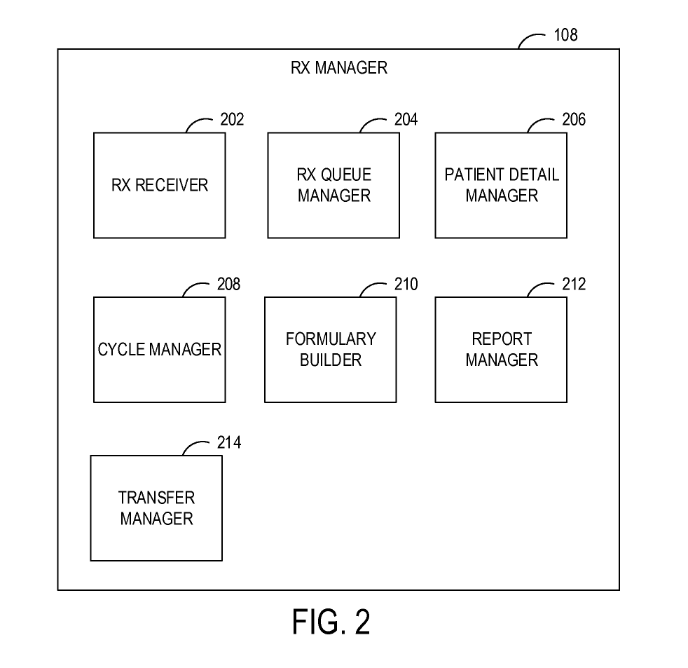

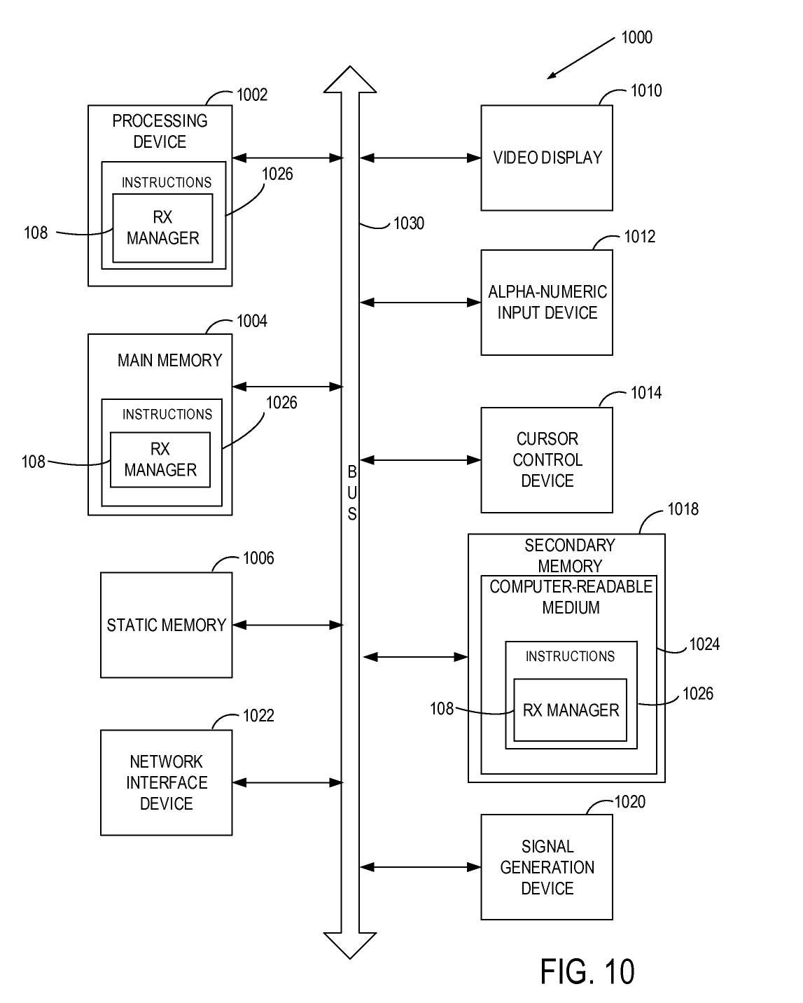

The server 102, in some embodiments, is a computing device that operates the prescription manager 108. The prescription manager 108 manages prescriptions and related activities. An embodiment of the server 102 is described in greater detail in relation to FIG. 10. An embodiment of the prescription manager is described in greater detail in relation to FIG. 2.

The network 104, in one embodiment, is a data communication structure that allows computing devices to share data. The network 104 may be any type of communication structure capable of sharing data between computing devices. Examples of the network 104 include an Ethernet network, a LAN, a Wi-Fi network, a WAN, an Extranet, and the Internet.

The client 106, in some embodiments, is a computing device to display information from the server 102. The computing device may receive data from the server 102 over the network 104. In some embodiments, the computing device transmits information to the server 102 over the network 104.

The client 106 may be any type of computing device capable of interacting with the server 102 to interact with the prescription manager 108. For example, the client 106 may be a computing device operating a web browser. In another embodiment, the client 106 may operate an application designed to work with the prescription manager 108, such as a dedicated app or application. The client may be a desktop computer, a laptop computer, a tablet computer, a smart phone, a PDA, a media player, or any other type of computing device.

In some embodiments, the prescription manager 108 receives data from a data source. The data source may be a local data source 110, a third party data source 112, or a remote data source 114. The local data source 110 may include a data storage device in the same location as the server 102. For example, the local data source 110 may be a database operating on the server. As used herein, the term “manager” refers to a process operating on a computer or similar electronic computing device that manipulates and transforms one or more numerical inputs represented as physical (e.g. electronic) quantities within the computer system's registers and memories into other data similarly represented as physical quantities within the computer system memories or registers or other such information storage, transmission, or display device.

The third party data source 112, in one embodiment, provides data to the prescription manager 108 from a third party. For example, the third party data source 112 may be controlled by a third party that has or uses data relating to prescriptions and would like to provide data to the prescription manager 108 and/or allow manipulation of data via the prescription manager 108. The third party data source 112 may be located in the same location as the server 102. For example, the third party data source 112 and the server 102 may be located in the same data center. In another embodiment, the third party data source 112 may be located remotely from the server 102. For example, the third party data source 112 may be located at a remote data center and communicate with the prescription manager via the network 104. In some embodiments, the prescription manager 108 does not access a third-party data source 112.

The remote data source 114, in some embodiments, provides data to the prescription manager 108 from a remote location. The remote data source 114 may communicate with the prescription manager 108 via the network 104.

The data accessible from the data source (the local data source 110, the third party data source 112, or the remote data source 114) may be used or manipulated by the prescription manager 108 to manage prescriptions. For example, the prescription manager 108 may populate one or more fields in the data source with information relating to a prescription. In another example, the prescription manager 108 may access data relating to a medication from the data source and use that data to influence the process of prescribing medications.

FIG. 2 is a block diagram depicting one embodiment of the prescription manager of FIG. 1. The prescription manager may include a prescription receiver 202, a prescription queue manager 204, a patient detail manager 206, a cycle manager 208, a formulary builder 210, a report manager 212, and a transfer manager 214. The prescription manager 108 manages prescriptions, including receiving inputs from health care providers, and provides guidance to improve results in response to these inputs.

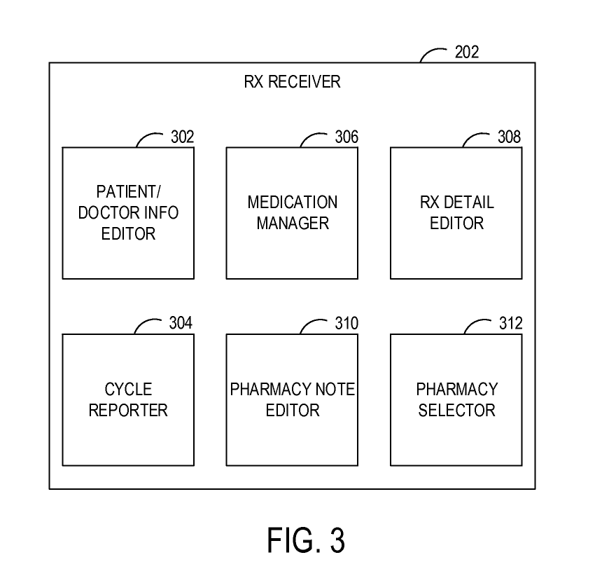

In one embodiment, the prescription receiver 202 receives and manages inputs from a health care provider relating to a prescription. The inputs may relate to a new prescription or to an existing prescription. In some embodiments, the prescription receiver 202 may use a previous prescription as a template for a new prescription. The prescription receiver 202 is described in greater detail below in relation to FIG. 3.

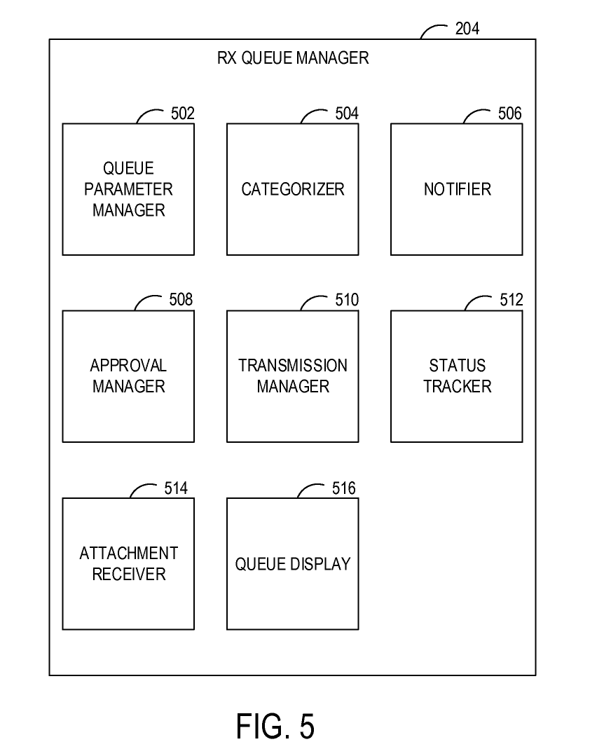

The prescription queue manager 204, in some embodiments, determines a queue into which a prescription is placed. The queue manager 204 may use one or more elements of the prescription to determine the queue into which the prescription is assigned. In one embodiment, the prescription queue manager 204 may assign a prescription already in one queue to another queue in response to an input. The prescription queue manager 204 is described in greater detail in relation to FIG. 5 below.

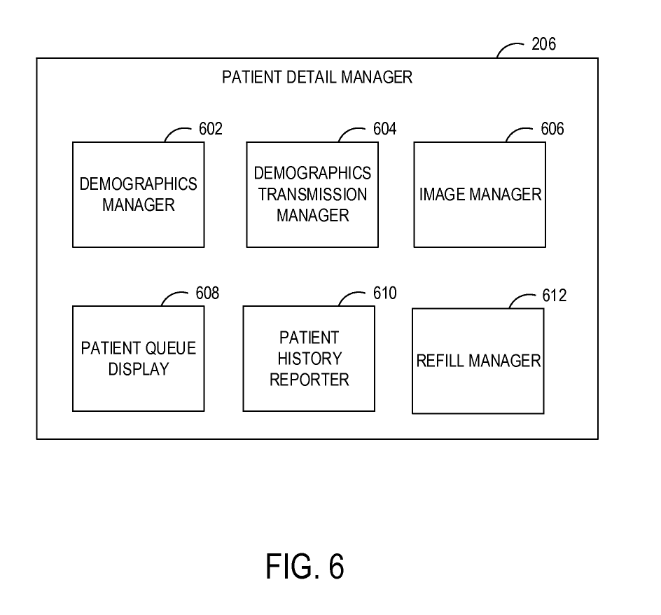

In some embodiments, the patient detail manager 206 receives inputs relating to a patient. The patient detail manager 206 may also display data relating to a patient. For example, the patient detail manager 206 may display demographic data relating to a patient and allow a health care provider to edit data relating to the patient. The patient detail manager 206 is described in greater detail below in relation to FIG. 6.

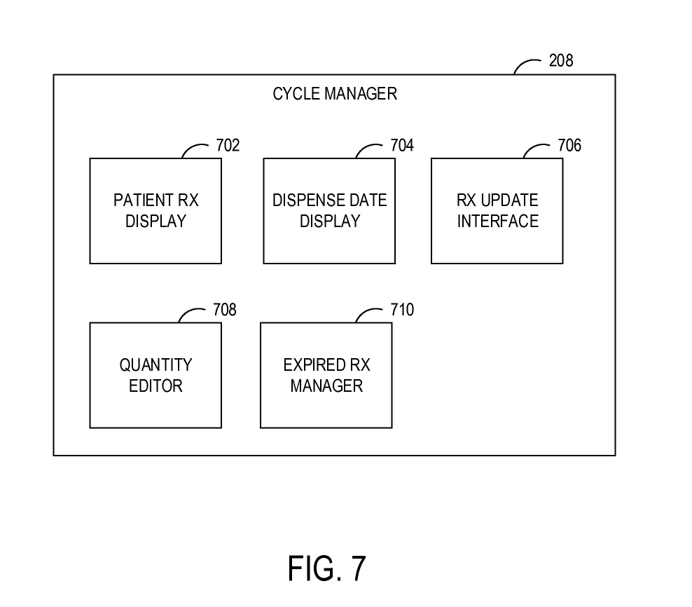

The cycle manager 208, in one embodiment, manages and displays dispense dates for medications, and assists the health care provider in coordinating dispensing multiple medications for a patient. For example, in response to a new prescription input into the prescription receiver 202, the cycle manager 208 may indicate that the patient had a previous dispense date for other medications. The cycle manager 208 may suggest or allow the health care provider to change the amount of dispensed medication to cause the new prescription's subsequent dispense date to match a pending dispense date for one or more existing prescriptions for the patient. The cycle manager 208 is described in greater detail in relation to FIG. 7 below.

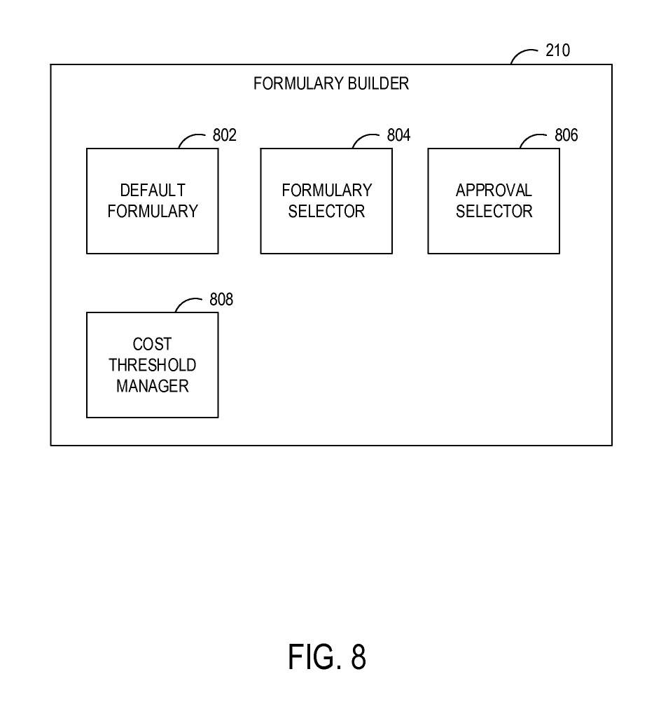

The formulary builder 210, in one embodiment, provides an interface to allow an administrator to indicate the acceptability of a medication under certain circumstances. For example, the administrator may mark a medication as being non-formulary, and the prescription manager 108 may indicate to a health care provider prescribing the non-formulary medication that administrator approval is required prior to prescription. The formulary builder 210 is described in greater detail in relation to FIG. 8 below.

The report manager 212, in certain embodiments, collects, manages, and displays data relating to use of the prescription manager 108. The report manager 212 may use data that describes characteristics of users of the prescription manager 108, patients for whom medication is prescribed, and medications prescribed. The report manager 212 may include any data that may be collected from the use of the prescription manager 108.

In one embodiment, the report manager 212 operates using data relating to a user of the prescription manager 108. For example, the report manager 212 may track the efficiency of a health care professional as he or she enters or manipulates prescriptions. This data may be compiled in a report that compares the relative efficiency of users and used for training In another example, the report manager 212 may track and compile data showing the amount of specific medications or categories of medications prescribed or approved by users. This data may be displayed to show, for example, which health care professionals are describing the most narcotics. In one embodiment, the report manager is configurable with a predetermined threshold that causes an alert to be sent to an administrator in response to a provider prescribing more than the threshold amount of a type of medication over a predetermined time.

In another embodiment, the report manager 212 operates using data relating to a patient receiving medications managed by the prescription manager 108. For example, the report manager 212 may track and display historic data showing medications received by the patient. This data may be accessed by a health care professional to better understand the long-term use of medications by the patient. In one embodiment, the report manager 212 may track and compile data showing the amount of specific medications or categories of medications received by patients. This data may be displayed to show, for example, which patients are receiving the most narcotics. In one embodiment, the report manager is configurable with a predetermined threshold that causes an alert to be sent to an administrator or a health care professional in response to a patient receiving more than the threshold amount of a type of medication over a predetermined time.

In some embodiments, the report manager 212 operates using data relating to medications prescribed using the prescription manager 108. For example, the report manager 212 may track costs associated with prescribed medications and display those costs to an administrator. In one embodiment, the report manager 212 may display and report on categories of medications, such as formulary and non-formulary medications prescribed, controls prescribed, non-therapeutically indicated medications prescribed, etc.

The transfer manager 214, in one embodiment, manages requests to transfer a prescription to a different pharmacy. The transfer manager 214 may receive a request to transfer a prescription to another pharmacy. In response to receiving the request to transfer the prescription, the transfer manager 214 may notify the user that a transfer has been requested.

The transfer manager 214 may receive an input from a user to transfer the prescription. In response to the input, the transfer manager may process the prescription to send it to the new pharmacy.

FIG. 3 is a block diagram depicting one embodiment of the prescription Receiver 202 of FIG. 2. In one embodiment, the prescription receiver 202 includes a patient/doctor info editor 302, a medication manager 306, a prescription detail editor 308, a cycle reporter 304, a pharmacy note editor 310, and a pharmacy selector 312. The prescription receiver 202 receives and manages inputs from a health care provider relating to a prescription. In some embodiments, the prescription receiver 202 prompts the health care provide with information in response to inputs.

The patient/doctor info editor 302, in one embodiment, provides an interface for editing information relating to the patient and the doctor. This interface receives inputs from a user. In some embodiments, the patient/doctor info editor 302 provides default input in response to an input from the user. For example, the patient/doctor info editor 302 may populate a “Doctor” field with a default doctor's name in response to an input of a patient's name. The patient/doctor info editor 302 may also provide an interface for geocoding the patient based on one or more factors. For example, the patient may be geocoded based on his or her home address or the facility at which the patient is being treated. In one embodiment, the patient/doctor info editor 302 receives an input from a user for geocoding. In an alternative embodiment, the patient/doctor info editor 302 provides a geocode for a patient automatically based on one or more factors.

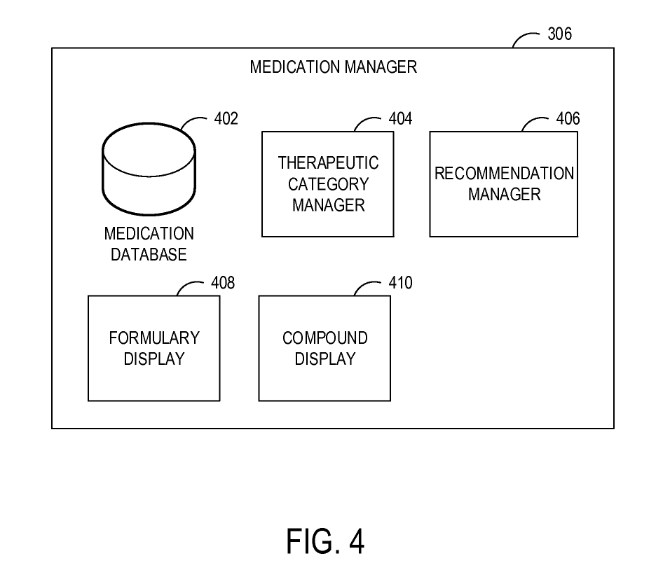

The medication manager 306, in one embodiment, provides an interface for editing information relating to a medication to be prescribed. The interface receives inputs from the user indicating which medication is to be prescribed. The medication manager 306 may provide feedback based on the medication selected, such as the formulary status of the medication. The medication manager 306 is described in greater detail in relation to FIG. 4 below.

The prescription detail editor 308, in one embodiment, provides an interface for editing information relating to a prescription, such as directions, quantity, refills, and packaging type. In some embodiments, the prescription detail editor 308 populates one or more fields with default values based on the medication, the patient, or the doctor. For example, a patient may be associated with a particular preferred packaging type, and that preferred packaging type may be automatically assigned in response to selecting that patient in the prescription receiver 202.

In some embodiments, the cycle reporter 304 indicates a dispense date for one or more existing prescriptions associated with a selected patient. The cycle reporter 304 may indicate to the user how to modify the amount dispensed to allow the new prescription to sync up with the existing one or more prescriptions. For example, the cycle reporter 304 may display a number of days since the last dispense date. In another example, the cycle reporter 304 may calculate and display a dispense quantity based on the prescription details such that the prescription will be due for a refill at the same time as the existing one or more prescriptions.

The pharmacy note editor 310, in one embodiment, provides an interface for associating a note with the prescription. For example, a user entering a prescription in the prescription receiver 202 may enter a note for the pharmacy providing instructions in the pharmacy note editor 310.

In some embodiments, the pharmacy selector 312 provides an interface for selecting a pharmacy for the prescription. In one embodiment, the pharmacy selector 312 provides a default pharmacy for the prescription. The default pharmacy may be determined by an administrator. For example a health care facility may have preferred pricing with a particular pharmacy, and the pharmacy selector 312 may provide that particular pharmacy as a default in response to the patient being associated with that health care facility. In another embodiment, the default pharmacy may be determined by distance from the facility, such that the default pharmacy is relatively close to the facility. In one embodiment, the pharmacy is selected based on a geocode associated with the patient or the facility at which the patient is being treated. In some embodiments, the pharmacy is selected based on a requested delivery time.

In some embodiments, the pharmacy selector 312 provides an interface for selecting a delivery time. The selection of a pharmacy may populate one or more delivery times for the prescription. For example, a particular pharmacy may specify specific delivery times that are available, and selection of the particular pharmacy in the pharmacy selector 312 may cause the pharmacy selector to provide these particular delivery times as options.

The pharmacy selector 312, in one embodiment, provides an interactive map for selecting a pharmacy. The interactive map may display a plurality of pharmacies in a general area. In one embodiment, the interactive map receives a location for the patient from the patient/doctor info editor 302 and displays pharmacies near the location for the patient.

FIG. 4 is a block diagram depicting one embodiment of the medication manager 306 of FIG. 3. The medication manager 306 includes a medication database 402, a therapeutic category manager 404, a recommendation manager 406, a formulary display 408, and a compound display 410. The medication manager 306, in one embodiment, provides an interface for selecting a medication to be prescribed, editing information relating to a prescription, and providing information relating to the medication to be prescribed. The medication manager may include a reference to potential fees that may be incurred with the request of additional services or products.

The medication database 402, in some embodiments, includes information relating to medications. The information may include a listing of available medications. The information may also include a listing different concentrations, sizes, or packaging available for medications. In some embodiments, the medication database 402 includes information relating to costs of medications. The medication database 402 may include information relating to fee structures for a medication based on a selected pharmacy and/or different delivery times or types.

In one embodiment, the medication manager 306 may access the medication database 402 in response to entry of a portion of a medication name to present the user with available medications matching the entry. The medication manager 306 may present the user with additional information from the medication database 402 relating to the selected medication. For example, the medication database 402 may present information relating to costs associated with a medication.

In some embodiments, the therapeutic category manager 404 associates a medication with therapeutic category in the medication database 402. The therapeutic category may indicate an appropriate and/or an inappropriate use of the medication. For example, the therapeutic category may be “Not hospice appropriate” to indicate whether the medication has been administratively approved for use in a hospice facility. In another example, the therapeutic category may indicate a condition for which the medication is specified. For example, the therapeutic category may indicate “anti-Parkinson's” as a therapeutic category for a particular medication.

In one embodiment, an administrator uses the therapeutic category manager 404 to associate a medication with a therapeutic category. In one embodiment, the therapeutic category manager 404 allows selection of a class of associated medications for assignment to a particular therapeutic category. For example, a class of associated medications may be different sizes, concentrations, or packaging types of the same medication.

The medication manager 306, in one embodiment, displays information from the therapeutic category manager 404 in response to selection of a medication. For example, a user may select a particular medication for prescription that is associated with a “Not hospice appropriate” therapeutic category. In response to this selection, the medication manager 306 may display an indication to the user that the selected medication is “Not hospice appropriate.”

In some embodiments, the therapeutic category manager 404 associates a color with a therapeutic category and the medication manager 306 displays the associated color.

In some embodiments, the recommendation manager 406 associates a recommendation with a predetermined set of parameters. For example, the recommendation manager 406 may indicate an alternative medication in response to selection of a “Not hospice appropriate” medication by a user. In one embodiment, an administrator uses the recommendation manager 406 to specify the predetermined set of parameters and the recommendation provided in response to those parameters. For example, the recommendation may indicate a generic medication in response to selection of a brand name medication for cost savings.

In one embodiment, the medication manager 306 displays information from the recommendation manager 406 in response to information provided by the user. For example, the user may select a brand name medication for prescription, and the medication manager may display an indication to the user that a generic medication is recommended.

The formulary display 408, in one embodiment, displays the formulary status of a medication in response to selection of the medication by a user. The formulary display provides users the opportunity to consider alternative medications in response to selection of a non-formulary medication. Formulary status of a medication is managed in the formulary builder 210.

The compound display 410 indicates whether a selected medication requires compounding in response to selection of the medication by a user.

FIG. 5 is a block diagram depicting one embodiment of the prescription queue manager 204 of FIG. 2. The prescription queue manager 204 includes a queue parameter manager 502, a categorizer 504, a notifier 506, an approval manager 508, a transmission manager 510, a status tracker 512, an attachment receiver 514, and a queue display 516. The prescription queue manager 204 places a prescription into a queue selected from a plurality of queues in response to one or more parameters associated with the prescription.

Each queue of the plurality of queues may have a particular workflow associated with the queue which applies prescriptions in the respective queue. For example, a “non-formulary” queue may include a requirement that an administrator, such as a director of nursing (“DON”) must approve or reject the non-formulary prescription before moving to another queue. Examples of queues that may be managed by the prescription queue manager 204 include “Editing,” “Non-formulary,” “Ready to Transmit,” “Rejected,” “Sent,” and “Awaiting Signature.”

In one embodiment, the queue parameter manager 502 manages one or more parameters used by the prescription queue manager 204 to categorize a prescription into a queue. The queue parameter manager 502 may be configurable by an administrator to control which parameters determine the categorization of a prescription. For example, an administrator may be able to specify that any new prescriptions with a status indicating that the medication is “non-formulary” should be categorized in a non-formulary queue. Examples of parameters that may influence categorization into a queue include formulary status, signature status, approval status, control status, and prescription submission status. As will be appreciated by one skilled in the art, any data relating to the prescription may act as a parameter influencing categorization into a queue.

The categorizer 504, in one embodiment, receives a prescription for categorization into a queue. In some embodiments, the categorizer 504 receives the prescription from the prescription receiver 202 after data is entered by a user. The categorizer 504 analyzes the prescription against one or more parameters supplied by the queue parameter manager 502 and determines into which queue the prescription should be placed. In one embodiment, the categorizer 504 places the prescription into the selected queue.

The notifier 506, in one embodiment, notifies one or more users in response to a prescription being placed into a queue. The notifier 506 may determine which user or users to notify based on the queue in which the prescription is placed. In some embodiments, the notifier 506 notifies a user in response to a characteristic of the prescription. For example, the notifier 506 may notify a DON in response to a prescription being placed in a non-formulary queue by the categorizer 504. This notification may indicate to the DON that the prescription must be approved by the DON in order for the prescription to progress beyond the non-formulary queue. In another embodiment, the notifier 506 may notify a user in response to an event relating to the prescription. For example, the notifier may notify a health care worker in response to the prescription being dispensed.

The approval manager 508 manages approval status for prescriptions requiring approval by an administrator. For example, the approval manager 508 may provide an interface for receiving an approval from a DON for a non-formulary medication. In one embodiment, the authorization may be in the form of a password or a PIN. The approval manager 508 may transmit a change in approval status for a prescription to the categorizer, indicating that the prescription should be re-categorized.

In one embodiment, the transmission manager 510 manages transmission of a prescription to a pharmacy for dispensing. The transmission manager 510 may transmit the prescription in response to the prescription being authorized or signed. In another embodiment, the transmission manager 510 may transmit the prescription in response to the prescription being moved by the categorizer 504 into a queue for transmission to a pharmacy. The transmission manager 510 may transmit the prescription in response to the prescription arriving into the transmission queue. In another embodiment, the transmission manager 510 may collect more than one prescription in the transmission queue before transmitting the prescriptions. In one embodiment, the transmission manager 510 transmits the prescriptions at a predetermined time interval. In another embodiment, the transmission manager 510 organizes prescriptions by pharmacy and transmits a batch of prescriptions directed to a particular pharmacy.

The transmission manager 510 may transmit a prescription or document to a single location in one embodiment. In another embodiment, the transmission manager 510 may transmit a prescription or document to multiple locations essentially simultaneously.

The transmission manager 510 may transmit a prescription using any method known in the art. For example, the transmission manager 510 may transmit a prescription using a fax sent to a pharmacy. In another example, the transmission manager 510 may transmit the prescription electronically over a network to the pharmacy, such as over the Internet. In a further example, the prescription manager 100 and the pharmacy may have access to a common database, and the transmission manager 510 may transmit the prescription to the pharmacy by changing a status associated with the prescription in the database to indicate that it is “transmitted.” In some embodiments, the transmission manager 510 encrypts data prior to transmission.

The status tracker 512, in some embodiments, tracks the status of a prescription as it progresses through the pharmacy. For example, the pharmacy may provide an indicator tracked by the status tracker 512 that shows that the prescription has been delivered. The status tracker 512 may display the status to a user.

The attachment receiver 514, in one embodiment, provides an interface for receiving an attachment to be associated with a prescription. For example, a scanned copy of a paper prescription with a physician signature may be required to dispense a particular medication. In this example, the categorizer 504 may place the prescription into a “needs scanned copy” queue and the attachment receiver 514 may allow a physician to upload a scanned copy, such as a smart phone photo, of a paper prescription to the prescription manager 100 for association with the prescription.

In one embodiment, the queue display 516 displays one or more queues to a user. The queue display 516 may allow the user to select from a plurality of queues for display. For example, the queue display 516 may provide a pull down menu with a list of available queues. The queues available for viewing may vary by permissions associated with the user.

Selection of a queue for viewing may result in a display of prescriptions associated with the selected queue by the queue display 516. The queue display 516 may also provide an interface for interaction with the approval manager 508. For example, a DON may access a non-formulary queue via the queue display 516. The queue display 516 may then provide a list of prescriptions that require approval from the DON prior to fulfillment. The DON may approve or reject one or more prescriptions from the displayed queue.

The queue display 516 may organize the prescriptions in the queue using any parameter. For example, the prescriptions may be organized by patient, by date written, by medication, by cycle date, or by any other parameter.

FIG. 6 is a block diagram depicting one embodiment of the patient detail manager 206 of FIG. 2. The patient detail manager 206 includes a demographics manager 602, a demographics transmission manager 604, an image manager 606, a patient queue display 608, a patient history reporter 610, and a refill manager. The patient detail manager 602 aggregates, manipulates, and displays details relating to a patient.

In one embodiment, the demographics manager 602 displays demographic information relating to a patient, such as names, identification numbers, addresses, diagnoses, preferences, allergies, insurance information, doctor information, and preferred pharmacy information. The demographics manager may also provide an interface for editing the demographic information.

The demographics transmission manager 604, in one embodiment, provides an interface for requesting transmission of the demographic information relating to a patient to a pharmacy. The demographics transmission manager 604 may transmit the demographic information using any method known in the art. For example, the demographics transmission manager 604 may transmit the demographic information using a fax sent to a pharmacy. In another example, the demographics transmission manager 604 may transmit the demographic information electronically over a network to the pharmacy, such as over the Internet. In a further example, the prescription manager 100 and the pharmacy may have access to a common database, and the demographics transmission manager 604 may transmit the demographic information to the pharmacy by changing a status associated with the demographic information in the database to indicate that it is “transmitted.” In some embodiments, the demographic information is encrypted prior to transmission.

The image manager 606, in some embodiments, provides access to images associated with a patient. For example the image manager 606 may provide a list of viewable images of historical prescriptions for the patient. Selection of a particular image from the list may allow the user to view the image and review previous prescriptions.

In one embodiment, the patient queue display 608 provides an interface to display queues in which the patent has an existing prescription. The patient queue display 608 may allow a user to select a displayed queue to show the prescriptions associated with the patient within the selected queue.

The patient history reporter 610, in one embodiment, provides an interface to display previously-entered prescriptions associated with a patient. The patient history reporter 610 may display a list of historical prescriptions for the patient, and may organize the prescriptions by any parameter associated with the prescriptions. For example, the list of historical prescriptions may be sortable by date, by medication name, by status, or any other parameter.

In some embodiments, the patient history reporter 610 displays a fill history associated with a prescription. For example, the fill history for a prescription may include a date dispensed, a quantity dispensed, and a status associated with dispensing the prescription.

The patient history reporter 610, in one embodiment, provides an interface to modify an existing prescription. For example, the interface may allow a user to discontinue a prescription.

In one embodiment, the patient history reporter 610 provides an interface to re-prescribe a prescription. For example, selection of an option in the interface may access the prescription manager 202 and populate one or more fields in the prescription manager 202 with data from the previous prescription.

The refill manager 612, in one embodiment, manages refills for a patient. The refill manager 612 may provide an interface for a user to access refill information and request a refill for a prescription. For example, the refill manager 612 may display a number of refills remaining for a patient and provide an input mechanism for the user to request that a remaining refill be dispensed. The request for a refill may be processed by another component of the system, such as by the prescription receiver 202.

FIG. 7 is a block diagram depicting one embodiment of the cycle manager 208 of FIG. 2. The cycle manager 208 includes a patient prescription display 702, a dispense date display 704, a prescription update interface 706, a quantity editor 708, and an expired prescription manager 710. The cycle manager 208 manages and displays dispense dates for medications and assists the health care provider in coordinating dispensing multiple medications for a patient.

The patient prescription display 702, in one embodiment, displays prescriptions associated with a patient. In some embodiments, the patient prescription display 702 displays prescriptions associated with a plurality of patients organized by patient. In one embodiment, the patient prescription display 702 displays a subset of the information associated with a prescription. For example, the patient prescription display 702 may display a prescription number, a medication name and type, and instructions associated with the medication.

In some embodiments, the dispense date display 704 shows a date on which the prescriptions for the patient were last dispensed. In an alternative embodiment, the dispense date display 704 displays an upcoming dispense date for prescriptions.

The prescription update interface 706, in one embodiment, provides an interface for directing future dispensing of medications in the prescription. For example, the user may indicate that the medication should be dispensed, should be held, or should be discontinued.

The quantity editor 708, in some embodiments, provides an interface for a user to indicate a quantity to dispense at the next dispense date. This may allow a user to synchronize dispense dates for medications for a patient. In one embodiment, the quantity editor 708 determines a quantity to dispense to synchronize dispense dates. The quantity editor may provide the determined quantity as a default in the interface.

In some embodiments, the expired prescription manager 710 displays a prescription that is expired. An expired prescription may require a new signature from a physician or a new approval from an administrator. In one embodiment, the expired prescription manager 710 provides an interface for manipulating the expired prescription. For example, the expired prescription manager 710 may receive an indication from a user that the expired prescription should be discontinued. In another example, the expired prescription manager 710 may receive from a user a request to notify a physician that a new signature is required.

FIG. 8 is a block diagram depicting one embodiment of the formulary builder 210 of FIG. 2. The formulary builder 210 includes a default formulary 802, a formulary selector 804, an approval selector 806, and a cost threshold manager 808. The formulary manager 210 provides an interface for managing a formulary.

The default formulary 802, in one embodiment, is a default listing of medications with associated default formulary statuses. The default formulary 802 may be provided to a facility for use by the facility or as a starting point for the facility do develop a customized formulary.

The formulary selector 804, in some embodiments, provides an interface for selecting a formulary status to be associated with a medication. The formulary selector 804 selection interface may include options such as radio buttons or pull down menus to allow a user to select formulary status for a medication. In one embodiment, the formulary selector 804 provides an interface to allow an administrator to select a group of medications for application of a formulary status. For example, the formulary selector 804 may allow a user to select multiple concentrations, sizes, and packaging options of a medication. In one embodiment, the formulary selector 804 prompts a user to select related medications for assignment to a formulary status. The medications may be related by name, associated treatment for a condition, cost, or any other relationship.

In one embodiment, the approval selector 806 provides an interface to indicate the authority required to approve prescription of a non-formulary medication. The authority for approval may indicate a type of user (e.g. an administrator or a DON). The authority for approval may indicate a particular user. In one embodiment, the approval selector 806 may indicate approval authority for all non-formulary medications with the selection of a single type of user or a particular user. In another embodiment, the approval selector 806 may allow specification of approval authority for individual medications or groups of medications.

The cost threshold manager 808, in one embodiment, provides an interface for indicating a cost threshold for a medication. In response to a prescription exceeding the cost threshold, the prescription may be treated by the prescription manager 108 in a manner similar to non-formulary medications, in that authorization from an administrator is required prior to the prescription being submitted to a pharmacy. The cost threshold manager 808 may allow indication of a cost threshold per prescription, per dispense, or per a predetermined time period, such as per week or per month.

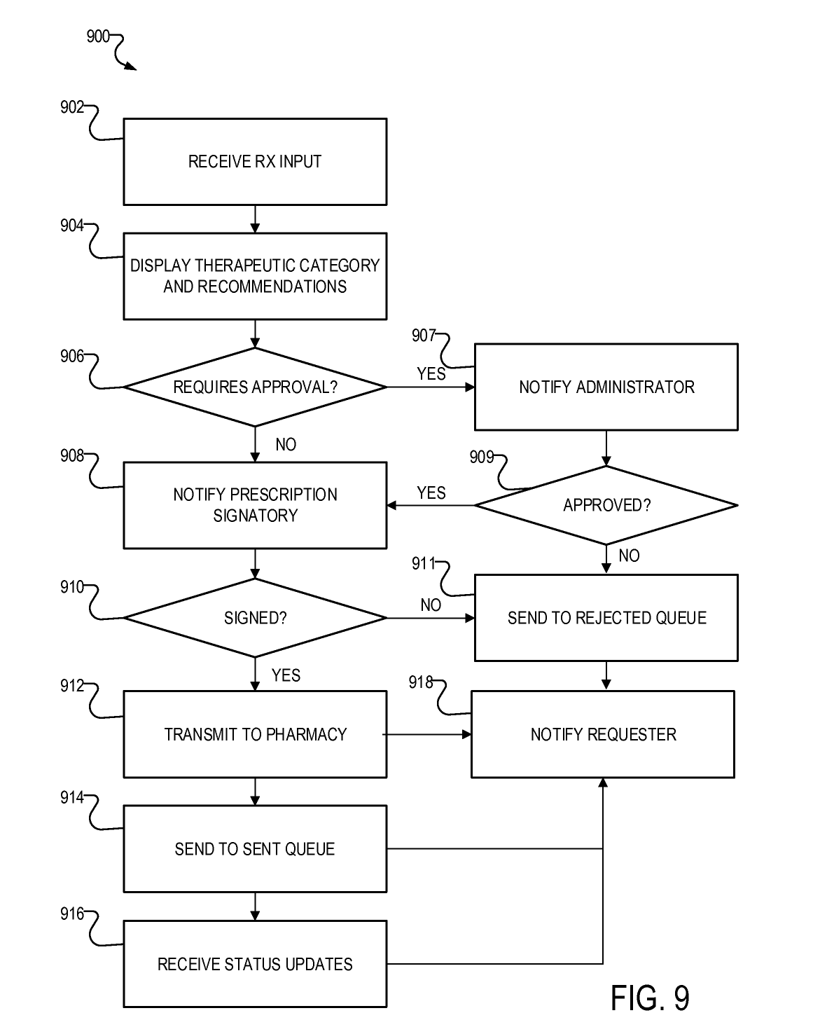

FIG. 9 depicts a flowchart diagram showing an embodiment of a method 900 for operating a prescription manager 108. The method is in certain embodiments a method of use of the system and apparatus of FIGS. 1-8, and will be discussed with reference to those figures. Nevertheless, the method may also be conducted independently thereof and is not intended to be limited specifically to the specific embodiments discussed above with respect to those figures.

As shown in FIG. 9, the prescription receiver 202 receives 902 a prescription input. The prescription input may include specification of a medication to be prescribed and a user to whom the medication will be prescribed.

The medication manager 306 displays 904 a therapeutic category and recommendations relating to the selected medication. The therapeutic category may provide information relating to the appropriateness of the medication based on the patient, the patient's condition, the patient's other medications, the facility treating the patient, or any other relevant parameter. The recommendations may indicate a preferable alternative medication or course of action. Recommendations may be based on cost, formulary status, the patient, the patient's condition, the patient's other medications, the facility treating the patient, or any other relevant parameter. The medication manager 306 may also display a formulary status and compounding requirements for a selected medication.

In one embodiment, the prescription queue manager 204 determines 906 if the prescription requires administrative approval and in response requests direction from the user to notify 907 an administrator in response to the determination 906. The prescription queue manager 204 may receive direction from the user relating to a single prescription or relating to multiple prescriptions in a single direction. In response to receiving direction from the user, the prescription queue manager 204 notifies 907 the administrator that authorization for a prescription has been requested. In another embodiment, the prescription queue manager 204 determines 906 if the prescription requires administrative approval and automatically notifies 907 an administrator if approval is required.

The prescription queue manager 204 may receive authorization from the administrator relating to a single prescription or relating to multiple prescriptions in a single authorization. In one embodiment, in response to receiving 909 approval from the administrator, or if the prescription queue manager 204 determines 906 that the prescription does not require approval, the prescription queue manager 204 requests direction from the user to notify 908 a prescription signatory authority (such as a physician). The prescription queue manager 204 may receive direction from the user relating to a single prescription or relating to multiple prescriptions in a single direction.

In response to receiving direction from the user, the prescription queue manager 204 notifies 908 the prescription signatory authority that the prescription is ready for signature. In an alternative embodiment, in response to receiving 909 approval from the administrator, or if the prescription queue manager 204 determines 906 that the prescription does not require approval, the prescription queue manager 204 notifies 908 the prescription signatory authority that the prescription is ready for signature.

The prescription queue manager 204 may receive a signature from the prescription signatory authority relating to a single prescription or relating to multiple prescriptions in a single authorization. In response to the prescription queue manager 204 receiving 910 a signature from the prescription signatory authority, the transmission manager 510 transmits 912 the prescription to a pharmacy. The prescription may be transmitted 912 by any known method, including electronically over a network, by sharing common access to a database, or by transforming the prescription into a fax and transmitting to the pharmacy.

In an alternative embodiment, the prescription queue manager 204 may send the prescription to a ready to transmit queue in response to receiving 910 a signature from the prescription signatory authority and the transmission manager 510 may transmit a plurality of prescriptions in the ready to transmit queue to one or more pharmacies.

In response to rejection of the prescription by the administrator (at 909) or the prescription signatory authority (at 910), the prescription queue manager 204 sends 911 the prescription to the rejected queue.

In response to the transmission manager 510 transmitting 912 a prescription to a pharmacy, the prescription queue manager 204 sends 914 the prescription to a sent queue. The status tracker 512 may receive 916 one or more status updates from the pharmacy indicating the progress of the prescription. The prescription manager 108 may notify 918 the user that requested the prescription in response to the progress of the prescription, including if the prescription is sent 911 to the rejected queue, transmitted 912 to a pharmacy, sent 914 to a sent queue, and in response to receiving 916 a status update.

FIG. 10 is a diagram of one embodiment of a computer system 1000 for facilitating the execution of the prescription manager 108. Within the computer system 1000 is a set of instructions for causing the machine to perform any one or more of the methodologies discussed herein. In alternative embodiments, the machine may be connected (e.g., networked) to other machines in a LAN, an intranet, an extranet, or the Internet. The machine can be a host in a cloud, a cloud provider system, a cloud controller or any other machine. The machine can operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1000 includes a processing device 1002, a main memory 1004 (e.g., read-only memory (ROM), flash memory, dynamic random access memory (DRAM) such as synchronous DRAM (SDRAM) or DRAM (RDRAM), etc.), a static memory 1006 (e.g., flash memory, static random access memory (SRAM), etc.), and a secondary memory 1018 (e.g., a data storage device in the form of a drive unit, which may include fixed or removable computer-readable storage medium), which communicate with each other via a bus 1030.

Processing device 1002 represents one or more general-purpose processing devices such as a microprocessor, central processing unit, or the like. More particularly, the processing device 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1002 may also be one or more special-purpose processing devices such as an application specific integrated circuit (ASIC), a field programmable gate array (FPGA), a digital signal processor (DSP), network processor, or the like. Processing device 1002 is configured to execute the instructions 1026 for performing the operations and steps discussed herein.

The computer system 1000 may further include a network interface device 1022. The computer system 1000 also may include a video display unit 1010 (e.g., a liquid crystal display (LCD) or a cathode ray tube (CRT)) connected to the computer system through a graphics port and graphics chipset, an alphanumeric input device 1012 (e.g., a keyboard), a cursor control device 1014 (e.g., a mouse), and a signal generation device 1020 (e.g., a speaker).

The secondary memory 1018 may include a machine-readable storage medium (or more specifically a computer-readable storage medium) 1024 on which is stored one or more sets of instructions 1026 embodying any one or more of the methodologies or functions described herein. In one embodiment, the instructions 1026 include instructions for the prescription manager 108. The instructions 1026 may also reside, completely or at least partially, within the main memory 1004 and/or within the processing device 1002 during execution thereof by the computer system 1000, the main memory 1004 and the processing device 1002 also constituting machine-readable storage media.

The computer-readable storage medium 1024 may also be used to store the instructions 1026 persistently. While the computer-readable storage medium 1024 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The instructions 1026, components and other features described herein can be implemented as discrete hardware components or integrated in the functionality of hardware components such as ASICS, FPGAs, DSPs or similar devices. In addition, the instructions 1026 can be implemented as firmware or functional circuitry within hardware devices. Further, the instructions 1026 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “providing,” “generating,” “installing,” “monitoring,” “enforcing,” “receiving,” “logging,” “intercepting,” “computing,” “calculating,” “determining,” “presenting,” “processing,” “confirming,” “publishing,” “receiving,” “applying,” “detecting,” “selecting,” “updating,” “assigning,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. In addition, unless specifically stated otherwise as apparent from the following discussion, it is appreciated that throughout the description, discussions utilizing terms such as “manager,” “receiver,” “generator,” “tracker,” “biaser,” “calculator,” “associator,” detector,” “publisher,” or the like, refer to processes operating on a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for managing prescriptions, the system comprising:
a server to operate a prescription manager;
wherein the server comprises:
a processing device; and
a memory;
wherein the prescription manager comprises:
a prescription receiver operating on the processing device of the server to receive from a care provider a prescription for a patient;
wherein the prescription receiver comprises a medication manager to display a recommendation in response to selection of a medication to be administered to the patient; and
a client to interact with the prescription manager, the client in communication with the server via a network, wherein the client displays the recommendation.

2. The system of claim 1, wherein the prescription manager further comprises an approval manager, wherein:
a prescription queue manager places the prescription in a queue selected from one or more predetermined queues in response to the prescription, the one or more predetermined queues including an awaiting approval queue and an approved queue;
the approval manager is configured to operate on prescriptions in the awaiting approval queue, wherein the approval manager moves the prescription to the approved queue in response to an approval input from an administrator.

3. The system of claim 2, wherein the prescription queue manager places the prescription in the awaiting approval queue in response to the prescription specifying a medication not included in a formulary.

4. The system of claim 2, wherein the prescription queue manager places the prescription in the awaiting approval queue in response to the prescription specifying a medication that exceeds a predetermined cost threshold.

5. The system of claim 2, wherein the prescription queue manager places the prescription in the awaiting approval queue in response to the prescription specifying a medication that does not correspond to a condition listed for the patient.

6. The system of claim 2, wherein:
the approval manager displays a listing of patients for whom prescriptions in the awaiting approval queue exist;
the approval manager displays information relating to one or more prescriptions for a patient in response to selection of the patient from the listing of patients; and
the approval manager receives an approval input from the administrator.

7. The system of claim 6, wherein the approval input comprises a predetermined code.

8. The system of claim 2, wherein the prescription manager transmits the prescription to a pharmacy in response to receiving a signature from a prescription signatory authority.

9. The system of claim 8, wherein the signature comprises an electronic signature, wherein the electronic signature comprises an electronically captured signature.

10. The system of claim 8, wherein the signature comprises a scanned copy of a handwritten signature.

11. The system of claim 8, wherein the signature comprises a scanned copy of the prescription.

12. The system of claim 2, wherein the prescription queue manager comprises a notifier module to notify an administrator in response to a prescription being placed in the awaiting approval queue.

13. The system of claim 2, wherein the prescription queue manager comprises a notifier module to notify an prescribing authority in response to a prescription being placed in the approved queue.

14. The system of claim 1, wherein the network is the Internet.

15. A method of managing prescriptions, the method comprising:
receiving a prescription for a patient from a care provider;
displaying a recommendation in response to the medication selected in the prescription, the recommendation received from a medication database;
transmitting to an administrator an electronic request for approval from the administrator in response to the prescription comprising a medication not listed in a formulary;
preventing a prescription comprising a medication not listed in the formulary from being transmitted to a pharmacy in the absence of approval from the administrator.

16. The method of claim 15, wherein the electronic request for approval is selected from the group consisting of a text message, an e-mail message, and a message within an application.

17. The method of claim 15, wherein the recommendation comprises an alternative medication suggestion.

18. A non-transitory computer readable storage medium including instructions that, when executed by a processing device, cause the processing device to perform a method comprising:
receiving a prescription for a patient from a care provider;
determining a therapeutic category for the medication, the therapeutic category indicating an appropriate use for the medication;
displaying a recommendation in response to the medication selected in the prescription, the recommendation received from a medication database;
transmitting to an administrator an electronic request for approval from the administrator in response to the prescription comprising a medication not listed in a formulary;
preventing a prescription comprising a medication not listed in the formulary from being transmitted to a pharmacy in the absence of approval from the administrator.

19. The non-transitory computer readable storage medium of claim 18, wherein the method further comprises:
transmitting the prescription to a pharmacy in response to receiving a signature from a prescription signatory authority.

20. The non-transitory computer readable storage medium of claim 19, wherein the method further comprises receiving an approval from an administrator.
